(19) United States
(12) Patent Application Publication
(10) Pub. No.: US 2009/0085496 A1
(43) Pub. Date: Apr. 2, 2009

(54) LED controller and lighting system

(76) Inventor: Ian Osborn, Littleton, CO (US)

Correspondence Address: Ian Osborn, 5526 South Simms Way, Littleton, CO, 80127, US

(21) Appl. No.: 11/906,009

(22) Filed: Sep. 29, 2007

(51) Int. Cl. H05B 41/36; H05B 41/00

(52) U.S. Cl. 315/294; 315/325

(57) ABSTRACT

A LED controller that allows the user to control the output intensity of one or more LED lights is disclosed. The intensity levels or brightness of the LED lights are not limited to 3, 4 or even 10 levels of light output; instead, the LED controller provides what appears to the human eye as a smooth range of changing brightness levels depending on the needs the user.

### TECHNICAL FIELD

The invention relates generally to the lighting industry and more particularly to an electronic LED controller and lighting system.

### BACKGROUND

Electrical lights have been around for well over 100 years. During that time, many variations and improvements in the technologies utilized to produce light have occurred. One of the most recent developments has been the widespread adoption of Light Emitting Diode (LED) lighting systems as a replacement for older incandescent and fluorescent systems.

In the last twenty years, rapid commercialization of LED technologies has occurred. LED lighting systems can be found in everything from hand-held flashlights to standard floor and desk lamps. In fact, the more powerful LEDs of recent manufacture are even being utilized in large-scale outdoor lighting projects.

Nevertheless, while LED lights have made impressive inroads in many areas of the lighting industry, LED systems still have a few problems and limitations. One such limitation is the general lack of LED controller systems that provide varying intensity outputs for LED lighting systems. A variety of multi-step systems are available, but the resulting lighting effect is similar to a standard three-way incandescent bulb in that three predefined levels of brightness are apparent rather than a smooth increasing and decreasing of the light output levels.

Another technology that is often utilized in LED systems is called a Pulse Width Modulator (PWM). PWMs are used to control the light output of LEDs. A PWM acts by providing segmented pulses of voltage to a LED, causing a flashing or pulsing effect in the light output of the LED. The pulsing effect causes the human eye to perceive an erratic flashing effect when a PWM is used to dim or brighten LED lights. Thus, a need exists for a LED controller and lighting system that can smoothly increase and decrease LED light output intensities without utilizing apparent brightness steps/levels or causing a pulsing of the LED.

### SUMMARY

Embodiments described and claimed herein address the foregoing problems by providing a LED controller that allows the user to control the output intensity of one or more LED lighting systems. The intensity levels or brightness of the LED lights are not limited to 3, 4 or even 10 levels of light output; instead, the LED controller provides what appears to the human eye as a smooth range of changing brightness levels depending on the needs of the user.

### BRIEF DESCRIPTION OF THE DRAWINGS

The aforementioned and other features and objects of the present invention and the manner of attaining them will become more apparent and the invention itself will be best understood by reference to the following description of a preferred embodiment and other embodiments taken in conjunction with the accompanying drawings, wherein:

FIG. 1 illustrates a view of an exemplary embodiment of a LED controller and lighting system operating on an alternating current power system.

FIG. 2 illustrates a close-up view of an exemplary embodiment of a LED controller and lighting system operating on an alternating current power system.

FIG. 3 illustrates a close-up view of an exemplary embodiment of a LED controller and lighting system operating on a direct current power system.

FIG. 4 illustrates a view of an exemplary embodiment of a LED controller and lighting system that utilizes a radio frequency module for wireless remote control functionality.

FIG. 5 illustrates a close-up view of an exemplary embodiment of a microchip component of a LED controller and lighting system.

### DETAILED DESCRIPTION

In one embodiment, a LED controller utilizes United States standard residential alternating current (A/C) as a power source (either 110 volt or 220 volt). In another embodiment, a LED controller utilizes direct current (D/C) as a power source (for example, a 12 volt solar-powered system). Other voltage types and sources are contemplated.

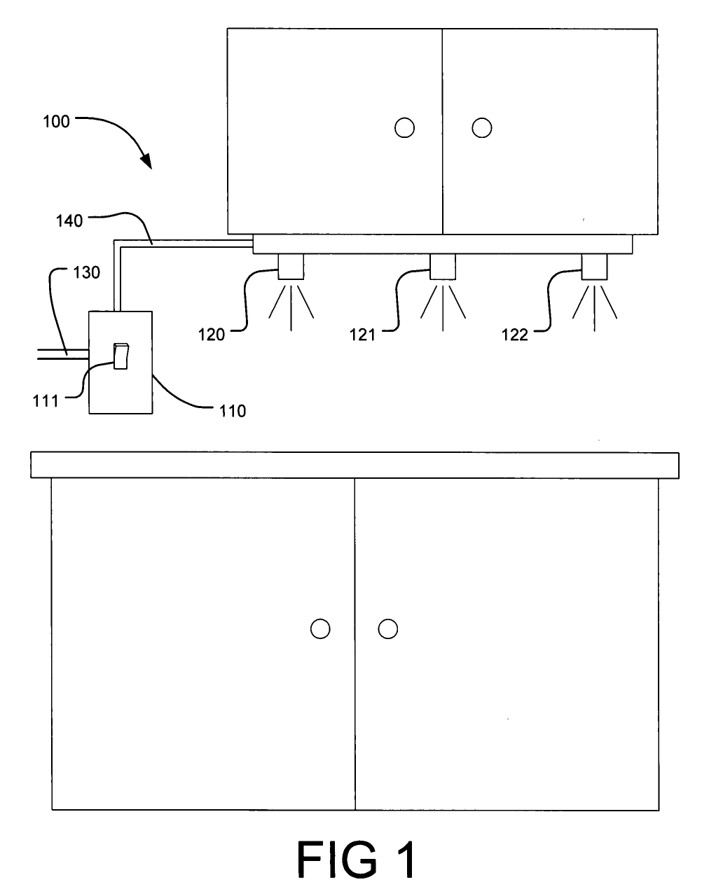

FIG. 1 illustrates an exemplary embodiment of a LED controller and lighting system 100 operating on an A/C power system. The primary components shown in FIG. 1 include: a LED controller 110; a system of LED lights 120, 121, and 122; an A/C power source 130; and the D/C power output 140. The LED controller 110 shown in FIG. 1 is illustrated as a simple switchbox. In other embodiments, other types of switches and/or controls are contemplated. In FIG. 1, the LED controller and lighting system 100 is operating on a standard A/C power source 130. The A/C power source 130 feeds into the LED controller 110. The LED controller 110 contains a number of subcomponents that are not shown in FIG. 1 (see detailed description of the LED controller 110 below). The subcomponents act on the incoming A/C power source 130 and output the D/C power output 140. As shown in FIG. 1, the D/C power output 140 is routed directly to the LED lighting system 120, 121, and 122. However, in alternate embodiments, the D/C power output 140 could connect to other components before being routed to the LED lighting system 120, 121, and 122.

Once the A/C power source 130 is routed to the LED controller 110, a user of the system can operate the rocker switch 111 to control the light output levels of the lighting system 120, 121, and 122. The LED controller 110 is connected to the lighting system 120, 121, and 122 by the D/C power output 140. Because the LED controller 110 does not rely upon a pulse width modulator (PWM) but instead utilizes a custom-coded microchip (among other components) to vary the light intensity of the lighting system 120, 121, and 122, the user will experience a gradual increasing or decreasing of light brightness/intensity while operating the rocker switch 111 instead of a pulsing or flashing effect common to PWM systems.

The lighting system 120, 121, and 122 as shown in FIG. 1 only has 3 LED lights. In other embodiments, the lighting system 120, 121, and 122 can contain fewer lights or more lights than that shown in FIG. 1. Furthermore, the lighting system 120, 121, and 122 can be composed of LED lights having different colors, sizes, shapes, intensities, etc.

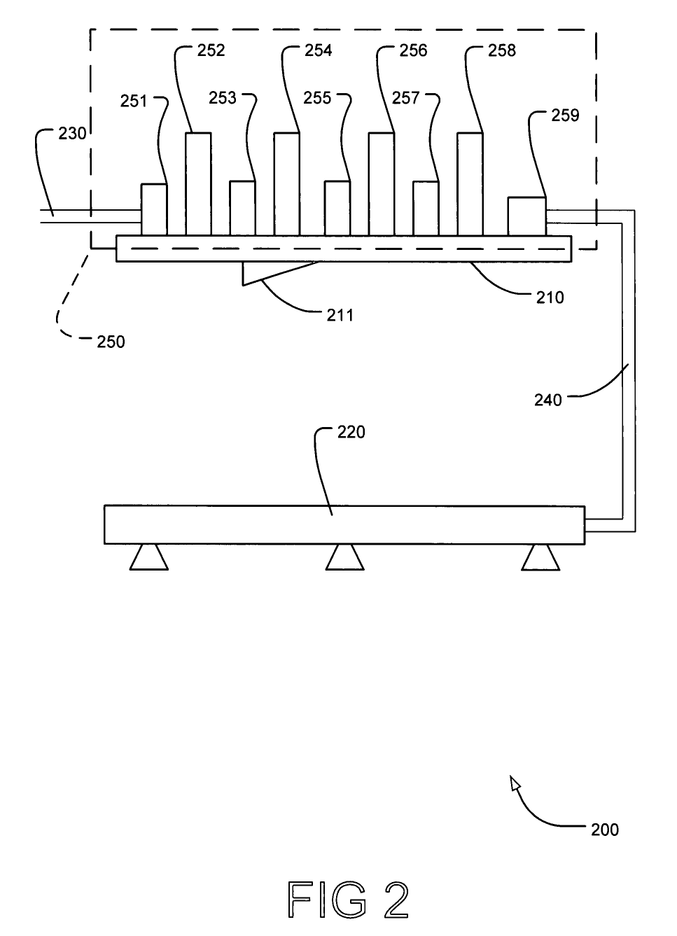

FIG. 2 illustrates a close-up view of an exemplary embodiment of a LED controller and lighting system 200 operating on an A/C power system. In the embodiment in FIG. 2, a switch plate 210 can be used to bring the A/C power from the A/C power source 230 to the terminal blocks 251. The switch plate 210 holds the LED controller 250 in position and the line wires coming from the A/C power source 230 bring the A/C power to the terminal blocks 251 to start the rectification of power to a D/C source. As shown in FIG. 2, the subcomponents of the LED controller 250 are represented by simple rectangles. Furthermore, in alternate embodiments, other subcomponents arranged in similar or different ways are contemplated.

Power is brought in to the LED controller 250 through the terminal blocks 251. The terminal blocks can consist of any components or subcomponents which function as a power input conduit for the LED controller 250. The terminal blocks 251 route power to a bridge rectifier 252. The bridge rectifier 252 transforms the A/C power into a D/C current. The resulting D/C current is then transferred to a capacitor-input filter 253 to smooth the voltage supply. Alternatively, a voltage regulator can be used either instead of or in addition to the capacitor-input filter 253, both to remove the last of the ripple and to deal with variations in supply and load characteristics.

Once the system has access to a D/C current, the power flow must be regulated. In one embodiment, the unregulated D/C power is routed to a capacitor 254 that subsequently produces a supply of relatively clean, uninterrupted D/C power output. Other embodiments may utilize other means or methods of regulating the D/C power. Furthermore, the power could be cleaned and regulated at a completely different location in the circuit, in yet another embodiment. Depending on the specific voltage requirements of other components, an additional voltage regulator 255 could be utilized to bring the exemplary 12 volt D/C current down to a 5 volt D/C current if needed for a 5 volt microchip, for example.

The resulting D/C current is then routed to a microchip 256. In one embodiment, a pre-programmed, static microchip 256 design is used. In another embodiment a re-programmable microchip 256 is used. Regardless of the type of microchip 256 used, its main function is to control the output of the 12 volt signal to the LED lighting system 220 in order to provide dimming and brightening of the LED lighting system 220. This is accomplished by using a programmable code-based microchip 256 that uses an oscillation chip with two hundred and fifty-five or more incremental steps rather than the segmented pulses of a standard PWM. In alternate embodiments, fewer than two hundred and fifty-five incremental steps may be used. In yet another embodiment, more than two hundred and fifty-five incremental steps may be used. Providing incremental steps at a much greater numerical value results in a smooth up and down transition of brightness/intensity of the LED lighting system 220 while maintaining the 12 volt D/C voltage supply. The transition of light output from low intensity to maximum intensity is achieved without the flickering effect of the traditional PWM. The program can be set to dim or intensify in variable increments. Those increments can be either an instantaneous change or a smooth transition without the flickering visual effect. This non-flickering effect is a result of the custom programming of the microchip 256.

In one embodiment, the microchip 256 is programmed to provide a range of brightness from 25% to 75% of the LED lighting system's 220 maximum lumens. In another embodiment, the microchip 256 specifies that on initial power-up, the LED lighting system 220 produces 10% output and then slowly progresses to 100% output over a 30 second period; while a user can halt the progression at any time.

A number of additional capacitors 257 and additional resistors 258 are also utilized throughout the LED controller in order to regulate power, depending upon the desired leg from the microchip 256 and its final function. The additional legs can be used to show and verify that the system has power to a unit (i.e., a LED on the unit showing that the system has power and is functioning). One or more additional LEDs can be used to show if a unit is at fault or has a line short, has crossed wires or a polarity problem, etc. Additional capacitors 257 and additional resistors 258 are utilized to provide the correct power requirements to the LEDs in order to activate them and the corresponding function(s).

In addition to the programmable microchip 256 dimming/brightening functions, the user can also manually affect the dimming/brightening. This is accomplished by operating a rocker switch 211 built into the switch plate 210 described above. The rocker switch 211 sends a signal to the microchip 256 to manually brighten or dim the LED lighting system 220.

The LED controller 250 has a set of outbound terminals 259. The outbound terminals 259 provide the conduit that allows outbound flow of D/C power output 240 from the LED controller 250 to the LED lighting system 220. In the embodiment shown in FIG. 2, the LED lighting system 220 has three LED lights. Other embodiments with a different number of LED lights are contemplated.

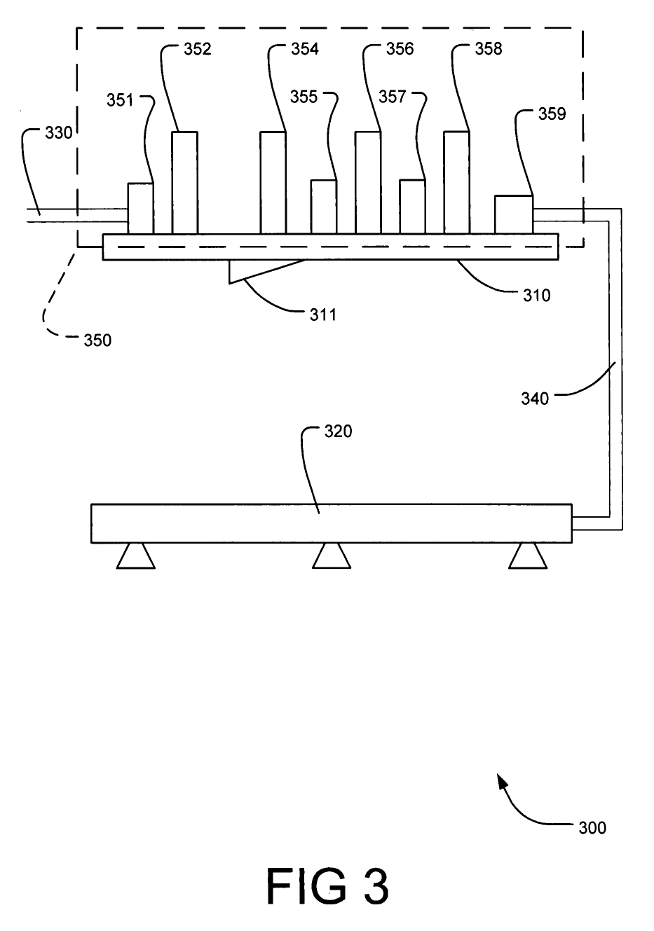

FIG. 3 illustrates a close-up view of an exemplary embodiment of a LED controller and lighting system 300 operating on a D/C power system. In the embodiment in FIG. 3, a switch plate 310 can be used to bring the D/C power from the D/C power source 330 to the terminal blocks 351. The switch plate 310 holds the LED controller 350 in position and the line wires coming from the D/C power source 330 bring the D/C power to the terminal blocks 351. As power is brought in to the LED controller 350 from the terminal blocks 351 it is routed to a voltage regulator 352 to bring the voltage to 12 volts D/C. Other voltages are contemplated.

In one embodiment, the unregulated D/C power is routed to a capacitor 354 that subsequently produces a supply of relatively clean, uninterrupted D/C power output. Other embodiments may utilize other means or methods for regulating the D/C power. Furthermore, the power could be cleaned and regulated at a completely different location in the circuit, in yet another embodiment. Depending on the specific voltage requirements of other components, an additional voltage regulator 355 could be utilized to bring the exemplary 12 volt D/C current down to a 5 volt D/C current if needed for a 5 volt microchip, for example.

The resulting D/C current is then routed to a microchip 356. In one embodiment, a pre-programmed, static microchip 356 design is used. In another embodiment a re-programmable microchip 356 is used. Regardless of the type of microchip 356 used, its main function is to control the output of the 12 volt signal to the LED lighting system 320 in order to provide dimming and brightening of the LED lighting system 320. This is accomplished by using a programmable code-based microchip 356 that uses an oscillation chip with two hundred and fifty-five or more incremental steps rather than the segmented pulses of a standard PWM. In alternate embodiments, fewer than two hundred and fifty-five incremental steps may be used. Providing incremental steps at a much greater numerical value results in a smooth up and down transition of brightness/intensity of the LED lighting system 220 while maintaining the 12 volt D/C voltage supply. The transition of light output from low intensity to maximum intensity is achieved without the flickering effect of the traditional PWM. The program can be set to dim or intensify in variable increments. Those increments can be either an instantaneous change or a smooth transition without the flickering visual effect. This non-flickering effect is a result of the custom programming of the microchip 356.

In one embodiment, the microchip 356 is programmed to provide a range of brightness from 50% to 100% of the LED lighting system's 320 maximum lumens. In another embodiment, the microchip 356 specifies that on initial power-up, the LED lighting system 320 produces 10% output and then slowly progresses to 80% output over a 20 second period; while a user can halt the progression at any time.

A number of additional capacitors 357 and additional resistors 358 are also utilized throughout the LED controller 350 in order to regulate power, depending upon the desired leg from the microchip 356 and its final function. The design of the LED controller 350 and additional legs can be used to attach a remote controlled RF modulator. The RF modulator can then perform the same functions as the rocker switch 311 to dim and/or brighten the lights.

In addition to the programmable microchip 356 dimming/brightening functions, the user can also manually affect the dimming/brightening. This is accomplished by operating a rocker switch 311 built into the switch plate 310 described above. The rocker switch 311 sends a signal to the microchip 356 to manually brighten or dim the LED lighting system 320. The LED controller 350 has a set of outbound terminals 359. The outbound terminals 359 provide the conduit that allows outbound flow of D/C power output 340 from the LED controller 350 to the LED lighting system 320.

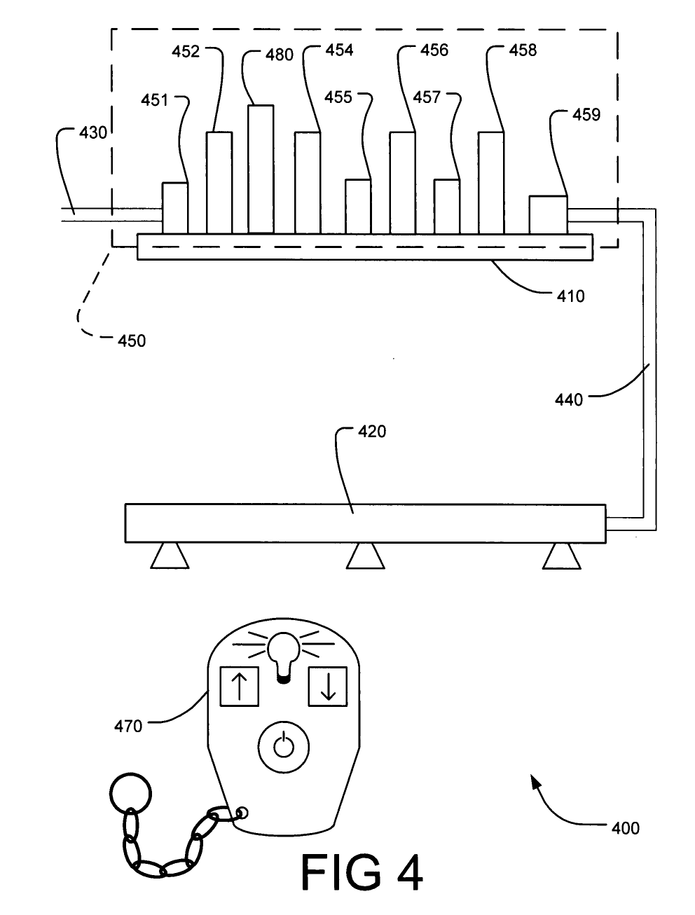

FIG. 4 illustrates a view of an exemplary embodiment of a LED controller and lighting system 400 that utilizes a radio frequency (RF) module 470 for remote control functionality. The LED controller 450 is similar to that shown in FIG. 3 in that it utilizes a D/C power source 430. However, instead of having a manual user control in the form of a rocker switch on the switch plate 410, the embodiment in FIG. 4 utilizes a RF module 470 to allow the user to wirelessly control the brightness/dimming features of the LED controller 450 in order to brighten or dim the LED lighting system 420. As can be seen in FIG. 4, the rocker switch 311 on the switch plate 410 from FIG. 3 has been removed and a RF module 470 with an RF interface 480 to the microchip 456 has been added to the LED controller 450. The remaining LED controller components are similar: the terminal blocks 451, voltage regulator 452, capacitor 454, additional voltage regulator 455, microchip 456, additional capacitors 457, additional resistors 458, and outbound terminals 459. Furthermore, the D/C power output 440 corresponds to that shown in FIG. 3.

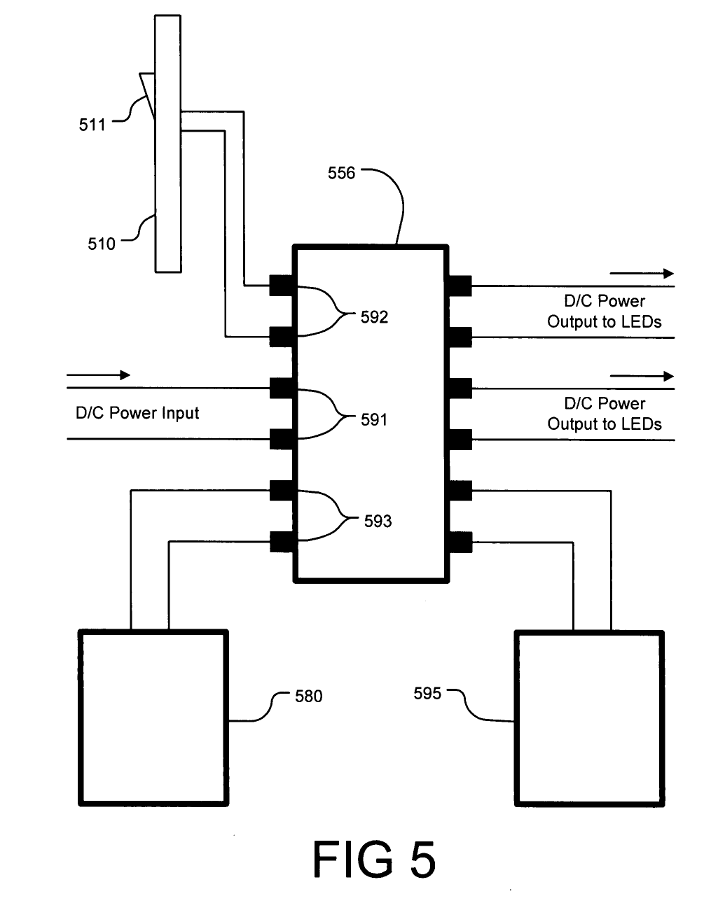

FIG. 5 illustrates a close-up view of an exemplary embodiment of a microchip component 556 of a LED controller and lighting system. As can be seen in FIG. 5, there are a number of inputs and outputs associated with the microchip 556. One set of inputs provides the microchip 556 with its supply of power. In the exemplary embodiment in FIG. 5, the power supply inputs 591 receive 5 volts of clean, regulated D/C power. A second set of inputs, the switch inputs 592, is shown in FIG. 5: they extend from the manual rocker switch 511 in the wall plate 510 to the microchip 556. The rocker switch 511 is triggered manually by the user and signals to the microchip 556 that the LED lighting system should either be dimmed or brightened. In response, the microchip 556 enters a repeating loop process in which the microchip 556 first determines whether the rocker switch 511 is activated. If it is, the microchip 556 then determines the switch state of the rocker switch 511: the switch is set to brighten or the switch is set to dim. In the first case, the microchip 556 increases the intensity level output to the LED lighting system and then enters a programmable-length delay mode before restarting the loop. In the second case, the microchip 556 decreases the intensity level output to the LED lighting system and then enters a programmable-length delay mode before restarting the loop. At the beginning of the loop, the microchip 556 once again determines whether the rocker switch 511 is active or inactive. If active, the loop progresses as above. If inactive, the microchip 556 exits the loop and holds steady the brightness level of the LED lighting system.

In another embodiment, the microchip 556 uses RF inputs 593 to determine the status of the RF interface 580. If the RF interface 580 is active and the rocker switch 511 is active then the microchip 556 enters a programmable-length delay mode before restarting the loop by determining whether the rocker switch 511 and the RF interface 580 are active. If only one of the two is active, the microchip 556 then determines whether the rocker switch 511 or the RF interface 580 is set to brighten or dim. Once that determination is completed, the loop progresses as above: the microchip 556 appropriately modifies the intensity level of the output to the LED lighting system, enters a programmable delay period, and then restarts the loop. If neither of the two is active, the microchip 556 takes no overt action.

In an alternative embodiment, the microchip 556 utilizes a non-volatile memory (NVM) 595 component. The NVM 595 allows the microchip 556 to reset itself to a user-defined or otherwise predetermined brightness/intensity level for the LED lighting system if the power is lost to the LED controller and lighting system.

The above specification, examples and data provide a description of the structure and use of exemplary embodiments of the described articles of manufacture and methods. Many embodiments can be made without departing from the spirit and scope of the invention.

What is claimed is:

1. A LED controller and lighting system, comprising:
a LED controller having at least one microchip;
a plurality of LED lights; and
a power source.

2. The LED controller and lighting system of claim 1, wherein the LED controller has a plurality of terminal blocks and the terminal blocks accept an input power from the power source.

3. The LED controller and lighting system of claim 2, wherein the terminal blocks transfer the input power to a bridge rectifier;
the bridge rectifier transforms the input power to a direct current;
the bridge rectifier transfers the direct current to a capacitor; and
the capacitor transfers the direct current to the microchip.

4. The LED controller and lighting system of claim 2, wherein the terminal blocks transfer the input power to a voltage regulator;
the voltage regulator regulates the input power to a predetermined voltage; and
the voltage regulator transfers the regulated input power to the microchip.

5. The LED controller and lighting system of claim 3, wherein the microchip is a programmable code-based microchip utilizing an oscillation chip with a plurality of incremental steps.

6. The LED controller and lighting system of claim 4, wherein the microchip is a programmable code-based microchip utilizing an oscillation chip with a plurality of incremental steps.

7. A LED controller and lighting system, comprising:
a plurality of LED lights;
a power source; and
a LED controller; wherein
the LED controller has at least a plurality of terminal blocks, a bridge rectifier, a microchip, and a means of controlling the microchip; and wherein
the terminal blocks accept an input power from the power source;
the bridge rectifier transforms the input power to a direct current; and
the microchip utilizes the direct current to power the plurality of LED lights.

8. The LED controller and lighting system of claim 7, wherein the means of controlling the microchip is a rocker switch which allows a user to smoothly brighten or dim the plurality of LED lights.

9. The LED controller and lighting system of claim 7, wherein the means of controlling the microchip is a radio frequency module which allows a user to wirelessly brighten or dim the plurality of LED lights.

10. The LED controller and lighting system of claim 7, wherein the means of controlling the microchip is a rocker switch and a radio frequency module which allow a user to smoothly brighten or dim the plurality of LED lights.

11. The LED controller and lighting system of claim 10, wherein the microchip utilizes a non-volatile memory component.

12. The LED controller and lighting system of claim 11, wherein the microchip is a programmable code-based microchip utilizing an oscillation chip with a plurality of incremental steps.

13. The LED controller and lighting system of claim 12, wherein the number of incremental steps is at least two hundred and fifty-five.

14. A method of smoothly changing the brightness of a LED lighting system using a LED controller, comprising:
inputting power to the LED controller;
inputting a brightness-change request to the LED controller; and
smoothly changing the brightness of the LED lighting system in response to the brightness-change request using a microchip in the LED controller.

15. The method of claim 14 wherein the brightness-change request is a request to dim the light output of the LED lighting system.

16. The method of claim 14 wherein the brightness-change request is a request to brighten the light output of the LED lighting system.
